(19) United States
(12) Patent Application Publication
(10) Pub. No.: US 2026/0219928 A1
(43) Pub. Date: Jul. 30, 2026

(54) TASK SCHEDULING NETWORK TRAINING METHOD BASED ON DEEP REINFORCEMENT LEARNING

(71) Applicant: CLOUD INTELLIGENCE ASSETS HOLDING (SINGAPORE) PRIVATE LIMITED, Singapore (SG)

(72) Inventors: Ming CHENG, Hangzhou, Zhejiang (CN); Yuejun YAN, Beijing (CN); Hongju MAO, Hangzhou, Zhejiang (CN); Wenyu LIU, Beijing (CN)

(21) Appl. No.: 19/143,814

(22) PCT Filed: Dec. 20, 2023
(86) PCT No.: PCT/CN2023/140084

§ 371 Date: Jun. 26, 2025

(30) Foreign Application Priority Data
Dec. 26, 2022 (CN) 202211676872.0

(51) Int. Cl. G06F 9/48; G06Q 50/06

(52) U.S. Cl. CPC G06F 9/4893; G06Q 50/06

(57) ABSTRACT

Embodiments of the present application disclose a task scheduling network training method based on deep reinforcement learning. The task scheduling network training method based on deep reinforcement learning includes: acquiring a job to be scheduled; scheduling a plurality of tasks by using a task scheduling network; determining rewards at a plurality of time steps according to a scheduling result of the task scheduling network, where respective reward at each of the time steps includes a carbon reward, an electricity cost reward and a task latency reward; calculating a return Gₜ according to the rewards at the plurality of time steps, where the return Gₜ is a cumulative reward from a time step t to the end of a scheduling process; adjusting parameters of the task scheduling network based on a gradient algorithm according to at least the return Gₜ.

### CROSS-REFERENCE TO RELATED APPLICATIONS

The present application is a National Stage of International Application No. PCT/CN2023/140084, filed on Dec. 20, 2023, which claims priority to Chinese patent application No. 202211676872.0, entitled “TASK SCHEDULING NETWORK TRAINING METHOD BASED ON DEEP REINFORCEMENT LEARNING” and filed with the China National Intellectual Property Administration on Dec. 26, 2022. The two applications are hereby incorporated by reference in their entireties.

### TECHNICAL FIELD

The present application relates to the field of data center task scheduling and, in particular, to a task scheduling network training method based on deep reinforcement learning.

### BACKGROUND

A server cluster and an auxiliary cooling system included in a data center are high energy-consuming devices that run continuously. In 2021, the energy consumption of data centers nationwide is approximately 216.6 billion kilowatt hours, accounting for 2.6% of the national total electricity consumption. Indirect greenhouse gas emissions caused by the electricity consumption reaches approximately 135 million tons, accounting for approximately 1.14% of the national carbon emissions. In the past ten years, the overall electricity consumption of various data center industries in my country has increased year by year at an average annual rate of more than 10%, and the issue of the energy consumption of the data center is attracting more and more attention. The “14th Five-Year Plan for the Development of the Information and Communications Industry” released on Nov. 17, 2021 clearly states that it is necessary to increase the green transformation of key areas, such as the data center. Therefore, low-carbon and economical operation of the data center is becoming an important direction for data center transformation.

The data center includes several servers. During the operation process of the data center, the job content received also includes several tasks. Reasonable scheduling of these tasks and assigning them to appropriate servers for processing is of great significance in reducing the energy consumption of the data center and improving the timeliness of task processing in the data center. However, the existing task scheduling algorithm usually ignores the requirements of low-carbon economic operation of the data center and cannot achieve low-carbon economic operation of the data center on the basis of ensuring the timeliness of task processing. Therefore, the operating costs of the data center remain high.

Therefore, the task scheduling algorithm in related technologies cannot achieve low-carbon economic operation of the data center on the basis of ensuring the timeliness of task processing. For the problem mentioned above, there is no effective solution proposed yet.

The above information disclosed in the background section is only provided to enhance understanding of the background of the technology described herein. Therefore, the background section may include information that does not form the prior art known to those skilled in the art.

### SUMMARY

Embodiments of the present application provide a task scheduling network training method based on deep reinforcement learning to at least solve the technical problem that a task scheduling algorithm in related technologies cannot achieve low-carbon economic operation of the data center on the basis of ensuring the timeliness of task processing.

According to a first aspect of an embodiment of the present application, a task scheduling network training method based on deep reinforcement learning is provided, including: acquiring a job to be executed, where the job to be executed includes a plurality of tasks; scheduling the plurality of tasks by using a task scheduling network; determining rewards at a plurality of time steps according to a scheduling result of the task scheduling network, where respective reward at each of the time steps includes a carbon reward, an electricity cost reward and a task latency reward, the carbon reward represents a carbon emission cost of a data center at the time step, the electricity cost reward represents an electricity cost of the data center at the time step, the task latency reward represents a task latency of the data center at the time step; calculating a return Gₜ according to the rewards at the plurality of time steps, where the return Gₜ is a cumulative reward from a time step t to the end of a scheduling process; and adjusting parameters of the task scheduling network based on a gradient algorithm according to at least the return Gₜ.

Further, the determining the rewards at the plurality of time steps according to the scheduling result of the task scheduling network includes: for any time step t, calculating the reward at the time step t according to a formula

$${r}_{t} = - {r}_{t}^{carbon} - {r}_{t}^{cost} - {r}_{t}^{Qos} ; where {r}_{t}^{carbon}$$

is a carbon reward at the time step t,

$${r}_{t}^{cost}$$

is an electricity cost reward at the time step t, and

$${r}_{t}^{Qos}$$

is a task latency reward at the time step t.

Further,

$${r}_{t}^{carbon} = - {P}_{t}^{DC} \cdot {e}_{t} \cdot {p}^{carbon} , {r}_{t}^{cost} = - {P}_{t}^{DC} \cdot {q}_{t} , {r}_{t}^{Qos} = - {\sum }_{i = 1}^{N} ( {T}_{i}^{cpu} \cdot {p}^{cpu} + {T}_{i}^{MEM} \cdot {p}^{MEM} ) ;$$

$$where$$

$${P}_{t}^{DC} = F ( M ) + {V}_{t} ( {U}_{t}^{cpu} , M ) , F ( M ) = M ( {P}_{idle} + ( PUE - 1 ) \cdot {P}_{peak} ) , {V}_{t} ( {U}_{t}^{cpu} , M ) = {\sum }_{i = 1}^{M} ( {P}_{peak} - {P}_{idle} ) [ 2 {U}_{i , t}^{cpu} - {( {U}_{i , t}^{cpu} )}^{r} ] , {P}_{t}^{DC}$$

is a power of the data center at the time step t, eₜ is a system carbon emission rate, p^{carbon} is a carbon emission price, qₜ is an electricity price at the time step t, N is an integer greater than 1,

$${T}_{i}^{cpu}$$

is an occupancy rate for CPU resources of a task i, p^{cpu} is a price of CPU utilization,

$${T}_{i}^{MEM}$$

is an occupancy rate for memory resources of the task i, p^{MEM} is a price of memory resource utilization, M is the number of servers in the data center, F(M) is a static power,

$${V}_{t} ( {U}_{t}^{cpu} , M )$$

is a variable power, P_{idle} is a rated power when a server is idle, Pₚₑₐₖ is a rated power when the server is fully occupied, an index r is a constant, and PUE is an energy efficiency index of the data center.

Further, the calculating the return Gₜ according to the rewards at the plurality of time steps includes: scaling up or scaling down the rewards at the plurality of time steps to obtain a plurality of scaled rewards, where a range of numerical intervals to which the plurality of scaled rewards belong is narrower than a range of numerical intervals to which the plurality of rewards belong; and calculating the return Gₜ according to the plurality of the scaled rewards.

Further, the scaling up or scaling down the rewards at the plurality of time steps to obtain the plurality of scaled rewards includes: for any time step t, calculating the scaled reward

$${r}_{t}^{′}$$

at the time step t according to a formula

$${r}_{t}^{′} = ( {r}_{t} - μ ) / ( σ + ε ) ,$$

where rₜ is the reward at the time step t, u is updated with an increase of a value of k by a formula μ←μ′+(r−μ)/k, σ is updated with an increase of the value of k by a formula σ←sqrt(s/k), s is updated by calculating using a formula s←σ+(r−μ′)*(r−μ), where k=n−1, n is a serial number of the time step t, in a case where k=0, μ=r, σ=r, r is a reward obtained at a first time step, and in a case serial k is not 0, μ=μ′.

Further, the adjusting the parameters of the task scheduling network based on the gradient algorithm according to the return Gₜ includes: determining an estimation of a current state value; and adjusting the parameters of the task scheduling network based on the gradient algorithm according to the return Gₜ and the estimation of the current state value.

Further, the adjusting the parameters of the task scheduling network based on the gradient algorithm according to the return Gₜ and the estimation of the current state value includes: iteratively updating a parameter θ of the task scheduling network using an equation

$$θ ← θ + {α}^{θ} {γ}^{t} δ \frac{{V}_{θ} {π}_{θ} ( {a}_{t} \vert {s}_{t} , {θ}_{t} )}{{π}_{θ} ( {a}_{t} \vert {s}_{t} , {θ}_{t} )} ,$$

where α^{θ} is a learning rate of the parameter θ, δ is a difference between the return Gₜ and the estimation of the current state value, γ^{t} is a discount factor at the time step t, π_{θ}(aₜ|sₜ, θₜ) is a probability that the task scheduling network takes an action a in an s state at the time step t, ∇_{θ}π₇₄ (aₜ|sₜ, θₜ) is a derivative of π_{θ}(aₜ|sₜ, θₜ) with respect to θ.

Further, the determining the estimation of the current state value includes: calculating an inner product of a parameter vector w and a feature vector x(sₜ) to obtain the estimation \hat{v}(sₜ, w) of the current state value; where x(sₜ) is a feature vector of a state at the time step t.

Further, the parameter vector w is iteratively updated by a formula w←w+α^{w}[Gₜ−\hat{v}(sₜ, w)]∇\hat{v}(sₜ, w); where α^{w} is a learning rate of \hat{v}(sₜ, w), and ∇\hat{v}(st, w) is a derivative of \hat{v}(st, w) with respect to w.

Further, the scheduling the plurality of tasks by using the task scheduling network includes: determining a plurality of executable actions, where the actions are used to instruct any one of the tasks to be scheduled to any one server for execution; inputting the plurality of executable actions into the task scheduling network, and outputting a probability that each of the executable actions is selected; determining a plurality of scheduling actions from the plurality of executable actions according to the probability that each of the executable actions is selected; and scheduling the plurality of tasks according to the plurality of scheduling actions.

Further, the determining the plurality of executable actions includes: determining one or more ready tasks from the plurality of tasks included in the job to be executed, where the ready tasks include tasks for which there is no parent task, and/or the ready tasks include tasks whose parent tasks have been executed, and the parent tasks are tasks that the ready tasks depend on when being executed; for each of the ready tasks, determining one or more target servers, where the target servers are servers that meet computing resources required by the ready tasks; and determining that an action which schedules any one of the ready tasks to any one of the target servers is one of the executable actions.

According to a second aspect of an embodiment of the present application, a data center task scheduling method based on deep reinforcement learning is also provided, including: acquiring a job to be scheduled, where the job to be scheduled includes a plurality of tasks to be scheduled; and scheduling the plurality of tasks to be scheduled by using a task scheduling network, where the task scheduling network is trained by using the afore-mentioned task scheduling network training method based on deep reinforcement learning.

According to a third aspect of an embodiment of the present application, a readable storage medium is also provided, on which computer instructions are stored, where when the computer instructions are executed by the processor, the afore-mentioned task scheduling network training method based on deep reinforcement learning is implemented; or when the computer instructions are executed by the processor, the afore-mentioned data center task scheduling method based on deep reinforcement learning is implemented.

According to a fourth aspect of the embodiment of the present application, a terminal device is provided. The terminal device includes a memory and a processor, where the memory has computer instructions stored thereon, and when the computer instructions are executed by the processor, the afore-mentioned task scheduling network training method based on deep reinforcement learning is implemented; or when the computer instructions are executed by the processor, the afore-mentioned data center task scheduling method based on deep reinforcement learning is implemented.

The task scheduling network training method based on deep reinforcement learning of the embodiment of the present application, includes: acquiring a job to be executed, where the job to be executed includes a plurality of tasks; scheduling the plurality of tasks by using a task scheduling network; determining rewards at a plurality of time steps according to a scheduling result of the task scheduling network, where respective reward at each of the time steps includes a carbon reward, an electricity cost reward and a task latency reward, the carbon reward represents a carbon emission cost of a data center at the time step, the electricity cost reward represents an electricity cost of the data center at the time step, the task latency reward represents a task latency of the data center at the time step; calculating a return Gₜ according to the rewards at the plurality of time steps, where the return Gₜ is a cumulative reward from a time step t to the end of a scheduling process; and adjusting parameters of the task scheduling network based on a gradient algorithm according to at least the return Gₜ. In the process of deep reinforcement training of the task scheduling network, after the scheduling network performs the scheduling operation on the plurality of tasks, the rewards at the plurality of time steps are calculated, and the return Gₜ in the entire scheduling process are calculated, and then the parameters of the task scheduling network are adjusted based on the gradient algorithm (such as gradient ascent or gradient descent) according to the return Gₜ. During the task scheduling network training process, corresponding reward will be established at each of the time steps, and the reward at each of the time steps include a carbon reward, an electricity cost reward and a task latency reward. The cumulative reward at the plurality of time steps is calculated, the return Gₜ is obtained, and the task scheduling network is trained based on the gradient algorithm according to the return Gₜ. Since during the task scheduling network training process, three reward items, namely the carbon reward, the electricity cost reward and the task latency reward, are introduced for the reward at each of the time steps, the carbon emission cost, electricity cost and task latency situation of the entire task execution process will be considered during the training process, which makes the data center scheduling process to be optimized in the direction of low carbon, economy, and low latency, thereby making the trained task scheduling network enable the data center to achieve low-carbon economic operation on the basis of ensuring low latency, and solving the technical problem that a task scheduling algorithm in related technologies cannot achieve low-carbon economic operation of the data center on the basis of ensuring the timeliness of task processing.

### BRIEF DESCRIPTION OF DRAWINGS

The drawings described herein are used to provide further understanding of the present application and constitute a part of the present application. The illustrative embodiments of the present application and their descriptions are intended to explain the present application and do not constitute improper limitations on the present application. In the drawings:

FIG. 1 is a schematic flowchart of a task scheduling network training method based on deep reinforcement learning according to an embodiment of the present application.

FIG. 2 is a schematic diagram of a task scheduling network training apparatus based on deep reinforcement learning according to an embodiment of the present application.

FIG. 3 is a schematic flowchart of a task scheduling network training method based on deep reinforcement learning according to an embodiment of the present application, which scales up or scaling down rewards at a plurality of time steps to obtain a plurality of scaled rewards.

FIG. 4 is a schematic diagram of a process of task scheduling network training using a task scheduling network training method based on deep reinforcement learning according to an embodiment of the present application.

### DESCRIPTION OF EMBODIMENTS

In order to enable those skilled in the art to understand solutions of the present application better, the technical solutions in the embodiments of the present application will be described clearly and completely below in conjunction with the drawings in the embodiments of the present application. Obviously, the described embodiments are part of the embodiments of the present application, rather than all of the embodiments. Based on the embodiments in the present application, all other embodiments obtained by those of ordinary skill in the art without creative work shall belong to the protection scope of the present application.

It should be noted that the terms “first”, “second”, and the like in the specification, claims, and the above-mentioned drawings of the present application are used to distinguish different objects, and are not necessarily used to describe a specific order.

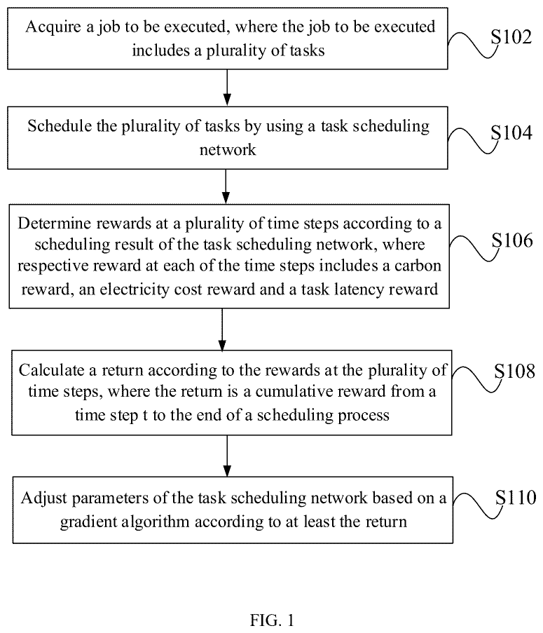

FIG. 1 is a task scheduling network training method based on deep reinforcement learning according to an embodiment of the present application. A task scheduling network is used to schedule tasks of a data center. The scheduling is to assign the tasks to a server for processing. When a task is scheduled to a server by the task scheduling network, the server performs calculation on the task. The task scheduling network training method based on deep reinforcement learning according to the embodiment of the present application is used to train the above-mentioned task scheduling network. As shown in FIG. 1, the method includes the following steps:
step S102, acquire a job to be executed, where the job to be executed includes a plurality of tasks;
step S104, schedule the plurality of tasks by using a task scheduling network;
step S106, determine rewards at a plurality of time steps according to a scheduling result of the task scheduling network, where respective reward at each of the time steps includes a carbon reward, an electricity cost reward and a task latency reward, the carbon reward represents a carbon emission cost of a data center at the time step, the electricity cost reward represents an electricity cost of the data center at the time step, the task latency reward represents a task latency of the data center at the time step;
step S108, calculate a return Gₜ according to the rewards at the plurality of time steps, where the return Gₜ is a cumulative reward from a time step t to the end of a scheduling process; and
step S110, adjust parameters of the task scheduling network based on a gradient algorithm according to at least the return Gₜ.

The task scheduling network training method based on deep reinforcement learning of the embodiment of the present application, includes: acquiring a job to be executed, where the job to be executed includes a plurality of tasks; scheduling the plurality of tasks by using a task scheduling network; determining rewards at a plurality of time steps according to a scheduling result of the task scheduling network, where respective reward at each of the time steps includes a carbon reward, an electricity cost reward and a task latency reward, the carbon reward represents a carbon emission cost of a data center at the time step, the electricity cost reward represents an electricity cost of the data center at the time step, the task latency reward represents a task latency of the data center at the time step, where the time step is a time point/moment; calculating a return Gₜ according to the rewards at the plurality of time steps, where the return Gₜ is a cumulative reward from a time step t to the end of a scheduling process; and adjusting parameters of the task scheduling network based on a gradient algorithm according to at least the return Gₜ. In the process of deep reinforcement training of the task scheduling network, after the scheduling network performs the scheduling operation on the plurality of tasks, the rewards at the plurality of time steps are calculated, and the return Gₜ in the entire scheduling process are calculated, and then the parameters of the task scheduling network are adjusted based on the gradient algorithm (such as gradient ascent or gradient descent) according to the return Gₜ. That is to say, during the task scheduling network training process, corresponding reward will be established at each of the time steps, and the reward at each of the time steps include a carbon reward, an electricity cost reward and a task latency reward. The cumulative reward at the plurality of time steps is calculated, the return Gₜ is obtained, and the task scheduling network is trained based on the gradient algorithm according to the return Gₜ. Since during the task scheduling network training process, three reward items, namely the carbon reward, the electricity cost reward and the task latency reward, are introduced for the reward at each of the time steps, the carbon emission cost, electricity cost and task latency situation of the entire task execution process will be considered during the training process, which makes the data center scheduling process to be optimized in the direction of low carbon, economy, and low latency, thereby making the trained task scheduling network enable the data center to achieve low-carbon economic operation on the basis of ensuring low latency, and solving the technical problem that a task scheduling algorithm in related technologies cannot achieve low-carbon economic operation of the data center on the basis of ensuring the timeliness of task processing.

That is to say, during the above-mentioned scheduling network training process, the reward at each of the time steps will be recorded into three parts: a carbon reward, an electricity cost reward and a task latency reward. The carbon reward represents a carbon emission cost of the data center at the time step. The data center's power consumption will generate the carbon emission cost, and the carbon reward is a reward item used to represent the carbon emission cost. Similarly, the data center will cause an electricity cost when running, and the electricity cost reward is a reward item used to represent the electricity cost. In addition, the embodiment of the present application also introduces a reward item of task latency reward. The task delay reward is used to represent task latency of the data center at the corresponding time step. The greater the latency caused by the data center when processing tasks at a certain time step, the greater the task latency reward. By incorporating these three into calculation of the reward and calculation of the total return Gₜ, the afore-mentioned three parts of the data center's operating costs can be optimized during the task scheduling network training process, which is conducive to the data center reducing an electricity expense and a carbon emission expense on the basis of ensuring the quality of service (QOS), and achieving the goal of low-carbon economic operation of the data center.

By applying deep reinforcement learning to the task scheduling network training, the task scheduling network can interact with the surrounding environment based on specific scheduling actions. Under the action and the environment, the state of the scheduling network will change, and the environment will give a return (reward). As the cycle continues, the task scheduling network continuously interacts with the environment to generate a lot of data. The reinforcement learning algorithm uses the generated data to modify the parameters of the task scheduling network itself, then interacts with the environment to generate new data, and uses the new data to further improve its own behavior. After several iterative learning, the scheduling policy network can learn better task scheduling policies and realize intelligent task scheduling.

The return Gₜ is a cumulative reward from the time step t to the end of the scheduling process, which is obtained by the accumulation of the rewards during the entire task scheduling process. In the actual accumulation process of the rewards at the plurality of time steps, rewards at different time steps can have different weights. For example, the return Gₜ can be calculated through a formula Gₜ=rₜ+γrₜ₊₁+ . . . +γ^{T-1-t}r_{T}. γ∈[0,1], γ is a discount factor that measures importance of current and future rewards. In a preferred embodiment, the current reward and the future reward are equally important, at this time γ=1.

In a specific embodiment, the determining the rewards at the plurality of time steps according to the scheduling result of the task scheduling network includes: for any time step t, calculating the reward at the time step t according to a formula

$${r}_{t} = - {r}_{t}^{carbon} - {r}_{t}^{cost} - {r}_{t}^{Qos} ; where {r}_{t}^{carbon}$$

is a carbon reward at the time step t,

$${r}_{t}^{cost}$$

is an electricity cost reward at the time step t, and

$${r}_{t}^{Qos}$$

is a task latency reward at the time step t.

In this embodiment, for any time step t, the reward consists of three parts, namely,

$${r}_{t}^{carbon} , {r}_{t}^{cost} and {r}_{t}^{Qos} ,$$

the reward is the cost. Since the lower the cost, the better, and thus a negative reward is adopted. The reward of the final time step t is calculated in the form of a sum of negative values of the afore-mentioned three parts of the reward, where

$${r}_{t}^{carbon}$$

is the carbon emission cost at the time step t,

$${r}_{t}^{cost}$$

is the electricity cost at the time step t,

$${r}_{t}^{Qos}$$

is the task latency situation at the time step t, and the task latency situation represents the latency situation of at least one of the tasks at the time step t. By adopting the reward calculation form, carbon emission costs, electricity costs, and task delays are included in the reward range. In the subsequent task scheduling network training process based on the gradient algorithm, the task scheduling network can be optimized in the direction of minimizing operating costs. The operating costs here take the carbon emission cost, the electricity cost, and the task latency situation into account. In the process of task scheduling, the finally trained task scheduling network can reduce the carbon emission cost and electricity cost while ensuring small task latency.

In order to calculate the afore-mentioned three parts of the rewards more accurately, in this embodiment,

$${r}_{t}^{carbon} = - {P}_{t}^{DC} \cdot {e}_{t} \cdot {p}^{carbon} ,$$

$${r}_{t}^{cost} = - {P}_{t}^{DC} \cdot {q}_{t} ,$$

$${r}_{t}^{Qos} = - {\sum }_{i = 1}^{N} ( {T}_{i}^{cpu} \cdot {p}^{cpu} + {T}_{i}^{MEM} \cdot {p}^{MEM} ) ;$$

$$where ,$$

$${P}_{t}^{DC} = F ( M ) + {V}_{t} ( {U}_{t}^{cpu} , M ) ,$$

$$F ( M ) = M ( {P}_{idle} + ( PUE - 1 ) \cdot {P}_{peak} ) , {V}_{t} ( {U}_{t}^{cpu} , M ) = {\sum }_{i = 1}^{M} ( {P}_{peak} - {P}_{idle} ) [ 2 {U}_{i , t}^{cpu} - {( {U}_{i , t}^{cpu} )}^{r} ] .$$

$${P}_{t}^{D C}$$

is a power of the data center at the time step t, and eₜ is a system carbon emission rate. The carbon emissions of coal power, wind power, photovoltaic power generation, etc. are different. Therefore, the proportion of various power generation forms in the real-time consumption of power by the power system is different, and the system carbon emission rate is also different. For example, a unit of the system carbon emission rate can be tCO₂/MWh, P^{carbon} is a carbon emission price at the time step t, the unit can be yuan/tCO₂, qₜ is an electricity price at the time step t, the unit can be yuan/Mwh, N is an integer greater than 1,

$${T}_{i}^{cpu}$$

is an occupancy rate for CPU sources of task i, and p^{cpu} is the CPU usage price. For example, the user uses the server in the data center, and is charged according to the usage of the server CPU. The unit of the price of CPU usage can be yuan/second,

$${T}_{i}^{MEM}$$

is an occupancy rate for memory sources of the task i, p^{MEM} is a price of memory resource utilization and the unit can be yuan/second, M is the number of servers in the data center, F(M) is a static power,

$${V}_{t} ( {U}_{t}^{cpu} , M )$$

is a variable power, P_{idle} is a rated power when a server is idle, Pₚₑₐₖ is a rated power when the server is fully occupied, an index r is a constant, and PUE is an energy efficiency index of the data center. In this embodiment, the carbon emission cost is calculated using a formula

$${r}_{t}^{carbon} = - {P}_{t}^{DC} \cdot {e}_{t} \cdot {p}^{carbon} , where {P}_{t}^{DC}$$

is the power of the data center at the time step t, eₜ is the system carbon emission rate, and p^{carbon} is the carbon emission price. The formula

$${r}_{t}^{cost} = - {P}_{t}^{DC} \cdot {q}_{t}$$

is used to calculate the electricity cost, where qₜ is the electricity price at the time step t, and the formula

$${r}_{t}^{Qos} = - {\sum }_{i = 1}^{N} ( {T}_{i}^{cpu} \cdot {p}^{cpu} + {T}_{i}^{MEM} \cdot {p}^{MEM} )$$

is used to calculate the task latency situation. This calculation method can achieve objective and accurate calculation of these three parts of costs, which will help improve the training effect of the subsequent task scheduling network.

In the process of task scheduling network training based on deep reinforcement learning, there is a problem that the task scheduling network does not converge or the convergence speed is slow. In order to solve the technical problem, in this embodiment, the calculating the return Gₜ according to the rewards at the plurality of time steps includes: scaling up or scaling down the rewards at the plurality of time steps to obtain a plurality of scaled rewards, where a range of numerical intervals to which the plurality of scaled rewards belong is narrower than a range of numerical intervals to which the plurality of rewards belong; and calculating the return Gₜ according to the plurality of the scaled rewards, where the return is a cumulative reward from the time step t to the end of the scheduling process. After research, the applicant found that the reason for slow or no convergence during the task scheduling network training based on deep reinforcement learning was due to large fluctuations in the reward calculation process, which affected the convergence of the training process. In this embodiment, after the rewards at the plurality of time steps are determined, these rewards are scaled up or scaled down to obtain a plurality of scaled rewards, and the range of numerical intervals to which the plurality of scaled rewards belong is narrower than the range of numerical intervals to which the plurality of rewards belong. Then the return Gₜ is calculated according to the plurality of scaled rewards, and the parameters of the task scheduling network are adjusted based on the gradient algorithm according to the specific training needs, at least according to the return Gₜ. In the process of training the task scheduling network using this training method, the parameters of the task scheduling network will not be adjusted directly based on the reward at each of the time steps. Instead, the plurality of rewards will be scaled up or down to obtain the plurality of scaled rewards, and then the return Gₜ will be calculated based on the scaled rewards, and then the parameters will be adjusted based on the gradient algorithm. In this process, by scaling up or down the rewards at the plurality of time steps, the scaled rewards are distributed in a smaller numerical range, which improves the stability of the reward distribution and can reduce or even avoid the situation where the rewards at some time steps fluctuate greatly relative to at other time steps. Therefore, the convergence speed of the task scheduling network is accelerated, the training effect is improved, and the problem of non-convergence or slow convergence during the training process of the task scheduling network is solved.

In this embodiment, in order to improve the effect of reward scaling and make the scaled reward more reliable and effective for the training of the task scheduling network, the calculation method of the scaled reward rᵣ′ is to divide the reward rₜ by the standard deviation of the sum of rolling discounts of rₜ. That is, the scaling up or scaling down the rewards at the plurality of time steps to obtain the plurality of scaled rewards includes: for any time step t, calculating the scaled reward

$${r}_{t}^{′}$$

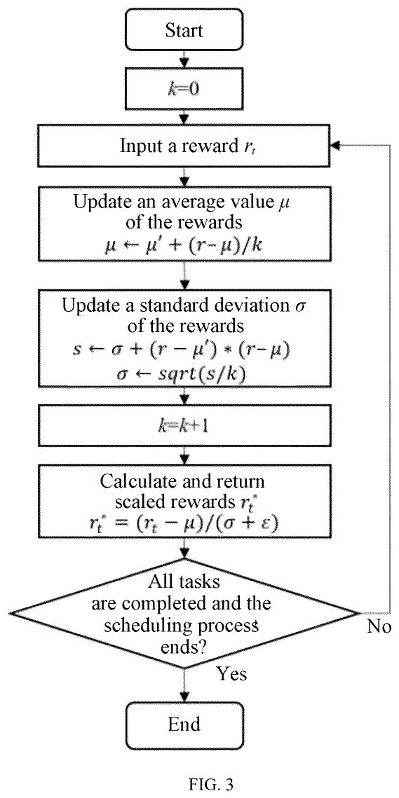

at the time step t according to a formula

$${r}_{t}^{′} = ( {r}_{t} - μ ) / ( σ + ε ) ,$$

where rₜ is the reward at the time step t, u is updated with an increase of a value of k by a formula μ←μ′+(r−μ)/k, σ is updated with an increase of the value of k by a formula σ←sqrt(s/k), s is updated by calculating using a formula s←σ+(r−μ′)*(r−μ), where k=n−1, n is a serial number of the time step t, in a case where k=0, μ=r, σ=r, r is a reward obtained at a first time step, and in a case serial k is not 0, μ=μ′. In this way, the problem of excessive or too small rewards at some time steps is eliminated, and the scaled rewards rₜ′ obtained after being scaled can also objectively and accurately represent the reward situation, thereby providing a basis for model optimization, which is conducive to improving the training effect of the task scheduling network and accelerating the convergence of the training process. The reward scaling process is explained more clearly below in conjunction with FIG. 3. FIG. 3 is a schematic flowchart of a task scheduling network training method based on deep reinforcement learning according to an embodiment of the present application, which scales up or scaling down rewards at a plurality of time steps to obtain a plurality of scaled rewards. As shown in FIG. 3, in the initial state, the value of k is 0. After the reward rₜ at the current time step t is obtained, the average value y is updated using the formula μ←μ′+(r−μ)/k, and the standard deviation a of the rewards is updated using the formula σ←sqrt(s/k). The s is updated using the formula s←σ+(r−μ′)*(r−μ), and the value of k is increased by 1. The scaled reward

$${r}_{t}^{′}$$

is calculated and returned according to the formula rₜ′=(rₜ−μ)/(σ+ε). When all task scheduling of the job to be executed is completed, the afore-mentioned scaled reward calculation process also ends.

In addition, the applicant also found that during the actual training process of the task scheduling network, if the number of the return Gₜ is large and the difference between good returns and bad returns is small, during the process of updating the parameters of the task scheduling network, the difference will be difficult to distinguish, which will have an adverse impact on the training process and lead to non-convergence or slow convergence. For example, Gₜ is a value in the order of millions, good returns and bad returns correspond to 1 million plus 5 and 1 million minus 5 respectively. The difference between the two Gₜ is not easy to distinguish. During the parameter update process, after performing some operations on these two Gₜ, the changes in the updated parameters will be minimal, which will also cause the training process to not converge or converge slowly.

In order to solve this technical problem, the adjusting the parameters of the task scheduling network based on the gradient algorithm according to the return Gₜ includes: determining an estimation of a current state value; and adjusting the parameters of the task scheduling network based on the gradient algorithm according to the return Gₜ and the estimation of the current state value. In this embodiment, the parameters of the policy network are adjusted by introducing the estimation of the current state value and combining the return Gₜ and the estimation of the current state value. At this time, the estimation of the current state value can be used as a reference base to assist in the adjustment of the parameters of the task scheduling network, which can accelerate the convergence of the training process.

In a specific embodiment, the adjusting the parameters of the task scheduling network based on the gradient algorithm according to the return Gₜ and the estimation of the current state value includes:
iteratively updating a parameter θ of the task scheduling network using an equation

$$θ ← θ + {α}^{θ} {γ}^{t} δ \frac{{∇}_{θ} {π}_{θ} ( {a}_{t} \vert {s}_{t} , {θ}_{t} )}{{π}_{θ} ( {a}_{t} \vert {s}_{t} , {θ}_{t} )} .$$

α^{θ} is a learning rate of the parameter θ, δ is a difference between the return Gₜ and the estimation of the current state value, γ^{t} is a discount factor at the time step t, π_{θ}(aₜ|sₜ, θₜ) is a probability that the task scheduling network takes an action a in an s state at the time step t, ∇_{θ}π_{θ}(aₜ|sₜ, θₜ) is a derivative of π_{θ}(aₜ|sₜ, θₜ) with respect to θ. In this embodiment, the afore-mentioned equation is used to determine the parameter θ of the task scheduling network, where δ is the difference between the return Gₜ and the estimation of the current state value. By using δ instead of Gₜ, δ can more clearly represent how much better or worse the scheduling result is than the previous average, thereby helping the task scheduling network to optimize parameters. For ease of understanding, this can be easily understood as: when a direction of a policy that works well is found, zoom in a little more in that direction. That is, the possibility of good things is increased, and the possibility of bad things is reduced, thereby solving the problem of non-convergence or slow convergence in the task scheduling network training process. As mentioned above, during the training process, the change of Gₜ may be very large. For example, Gₜ is a value in the order of millions, Gₜ produced by a better scheduling policy is 1 million plus 5, and Gₜ produced by a relatively poor scheduling policy is 1 million minus 5. The difference in this order of magnitude is very small (the difference between 1000005 and 999995 is small), and after multiplying by the learning rate, it will be difficult to distinguish between the two. By introducing an estimation of the state value, the difference between the return Gₜ and the estimation of the current state value can be used to increase the degree of discrimination between the two. For example, subtract 1 million from both to get 5 and −5. The difference between the two is more obvious, which is more beneficial to the training process, and helps the policy network learn the scheduling policy.

In this embodiment, the determining the estimation of the current state value includes: calculating an inner product of a parameter vector w and a feature vector x(sₜ) to obtain the estimation \hat{v}(st, w) of the current state value; where x(sₜ) is a feature vector of a state at the time step t. Using the value function approximation \hat{v}(sₜ, w) as the current state value can facilitate the estimation of the current state value. Specifically, the estimation \hat{v}(st, w) of the current state value can be calculated by an inner product of the parameter vector w and the feature vector x(sₜ), where there is a feature vector for the state sₜ at each time step t. In a specific embodiment, the feature vector is x(sₜ)=(x₁(sₜ), x₂(sₜ) . . . , x_{M+m+1}(sₜ)).

In this embodiment, in order to ensure the accuracy of the current state value estimation, the parameter vector w will be updated together with θ. Specifically, the parameter vector w is iteratively updated by a formula w←w+α^{w}[Gₜ−\hat{v}(sₜ, w)]∇\hat{v}(sₜ, w); where α^{w} is a learning rate of \hat{v}(sₜ, w), and ∇\hat{v}(st, w) is a derivative of \hat{v}(sₜ, w) with respect to w.

The scheduling the plurality of tasks by using the task scheduling network includes: determining a plurality of executable actions, where the actions are used to instruct any one of the tasks to be scheduled to any one server for execution; inputting the plurality of executable actions into the task scheduling network, and outputting a probability that each of the executable actions is selected; determining a plurality of scheduling actions from the plurality of executable actions according to the probability that each of the executable actions is selected; and scheduling the plurality of tasks according to the plurality of scheduling actions. In the process of using the task scheduling network to schedule the plurality of tasks, the plurality of executable actions are determined. The action is to assign a task to a server at a certain time step, which is used to instruct any task to be scheduled to any server for execution. For example, the action aₜ(φᵢ, sⱼ) is an executable action, which is to assign the task φᵢ to the server sⱼ for processing. After determining the plurality of executable actions, the plurality of executable actions will be input into the task scheduling network to output the probability of each executable action being selected. That is to say, the task scheduling network outputs a probability. The greater the probability, the more likely the corresponding task scheduling network is to select the action. Based on the probability output by the task scheduling network, the scheduling action can be selected from the afore-mentioned executable actions, and the task scheduling is performed according to the scheduling action.

In this embodiment, how to determine the plurality of executable actions is explained. The determining the plurality of executable actions includes: determining one or more ready tasks from the plurality of tasks included in the job to be executed, where the ready tasks include tasks for which there is no parent task, and/or the ready tasks include tasks whose parent tasks have been executed, and the parent tasks are tasks that the ready tasks depend on when being executed; for each of the ready tasks, determining one or more target servers, where the target servers are servers that meet computing resources required by the ready tasks; and determining that an action which schedules any one of the ready tasks to any one of the target servers is one of the executable actions.

In the afore-mentioned process of determining the plurality of executable actions, the determination will be based on inter-task dependencies and the task's requirements for computing resources. Specifically, one or more ready tasks will be determined from the plurality of tasks, where the ready tasks include the tasks for which there is no parent task, and/or the ready tasks include the tasks whose parent tasks have been executed, and the parent tasks are tasks that the ready tasks depend on when being executed. For each ready task, a corresponding target server will be determined. The target server needs to meet the computing resource requirements of the ready task. For example, if 10 servers can meet the computing resources required by a ready task, these 10 servers are all target servers, and the action of scheduling the ready task to any one of these 10 servers is an executable action. In this way, during the task scheduling process, the dependencies between tasks and the tasks' requirements for computing resources can be fully considered, which is beneficial to improving the rationality of task scheduling.

In some implementation scenarios, the input dimension of the task scheduling network is fixed, and the number of arriving tasks is unknown, that is, the number of tasks is changing. At this time, in order to smoothly implement the training of the task scheduling network, in this embodiment, determining the one or more ready tasks from the plurality of tasks included in the job to be executed includes: determining a front preset number of ready tasks from the plurality of tasks included in the job to be executed according to a task arrangement order. That is to say, the front preset number of ready tasks are determined from the plurality of tasks included in the job to be executed according to the task arrangement order. In other words, the task scheduling network observes a fixed number of ready tasks during each scheduling process, thereby ensuring that the input dimension is fixed and saving computing overhead.

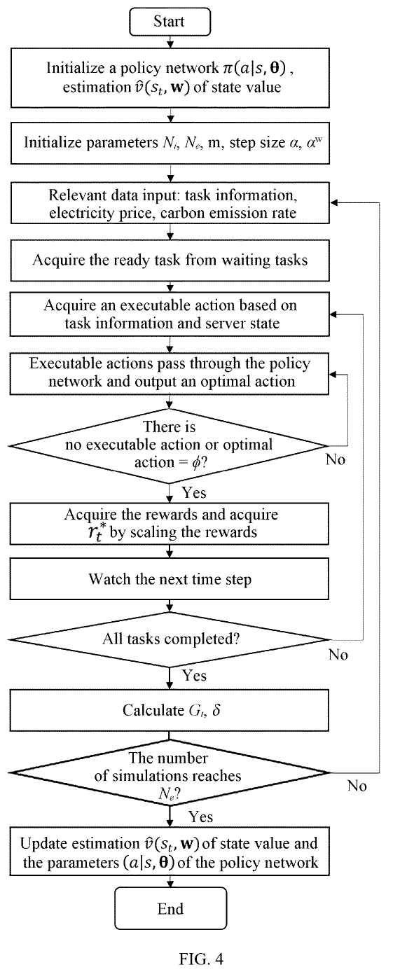

The task scheduling network training method based on deep reinforcement learning according to the embodiment of the present application will be described below with reference to FIG. 4. FIG. 4 is a schematic diagram of a process of task scheduling network training using a task scheduling network training method based on deep reinforcement learning according to an embodiment of the present application. As shown in FIG. 4, at the beginning of training, a policy network π(a|s, θ) and an estimation \hat{v}(sₜ, w) of the state value will be initialized, where the policy network is the afore-mentioned task scheduling network, and parameters Ni, Nₑ, m, α, α^{w}, etc. Nᵢ is the number of iterations in the training process of the task scheduling network, Nₑ is the number of iteration rounds, m is the number of tasks observed in the job to be executed, α is the learning rate of the parameter θ, α^{w} is the learning rate of \hat{v}(sₜ, w), and some relevant data is input into the task scheduling network, such as task information of the job to be executed, electricity price, carbon emission rate, etc. Afterwards, the ready task will be obtained from the waiting task. As mentioned above, the ready task includes a task for which there is no the parent task, and/or the ready task includes a task whose parent task has been executed. For each ready task, the corresponding executable action (i.e., feasible action) is determined, and then the task scheduling network calculates the probability of each executable action being selected, and then outputs a better action based on the probability and makes a task scheduling decision. Until there is no executable action or the better action is no action, the entire task scheduling process is completed. At this time, the reward rₜ at each time step t can be acquired and scaled to obtain the plurality of scaled rewards

$${r}_{t}^{′} .$$

After the scaled rewards at all time steps are calculated, the return Gₜ can be calculated based on the scaled rewards of the plurality of time steps. When the number of simulation scheduling processes reaches Gₜ, iterative optimization will be performed to update the estimation \hat{v}(sₜ, w) of the state value and the parameter θ of the policy network θ.

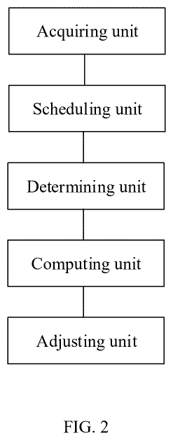

Secondly, as shown in FIG. 2, an embodiment of the present application also provides a task scheduling network training device based on deep reinforcement learning, including: an acquiring unit, configured to acquire a job to be executed, where the job to be executed includes a plurality of tasks; a scheduling unit, configured to schedule the plurality of tasks by using a task scheduling network; a determining unit, configured to determine rewards at a plurality of time steps according to a scheduling result of the task scheduling network, where respective reward at each of the time steps includes a carbon reward, an electricity cost reward and a task latency reward, the carbon reward represents a carbon emission cost of a data center at the time step, the electricity cost reward represents an electricity cost of the data center at the time step, the task latency reward represents a task latency of the data center at the time step; a calculating unit, configured to calculate a return Gₜ according to the rewards at the plurality of time steps, where the return Gₜ is a cumulative reward from a time step t to the end of a scheduling process; and an adjusting unit, configured to adjust parameters of the task scheduling network based on a gradient algorithm according to at least the return Gₜ.

For the task scheduling network training device based on deep reinforcement learning in such setting, after the acquiring unit acquires a job to be executed, where the job to be executed includes a plurality of tasks; the scheduling unit schedules the plurality of tasks by using a task scheduling network; the determining unit determines rewards at a plurality of time steps according to a scheduling result of the task scheduling network, where respective reward at each of the time steps includes a carbon reward, an electricity cost reward and a task latency reward, the carbon reward represents a carbon emission cost of a data center at the time step, the electricity cost reward represents an electricity cost of the data center at the time step, the task latency reward represents a task latency of the data center at the time step; the calculating unit calculates a return Gₜ according to the rewards at the plurality of time steps, where the return Gₜ is a cumulative reward from a time step t to the end of a scheduling process; and finally the adjusting unit adjusts parameters of the task scheduling network based on a gradient algorithm according to at least the return Gₜ. In the process of deep reinforcement training of the task scheduling network, after the scheduling network performs the scheduling operation on the plurality of tasks, the rewards at the plurality of time steps are calculated, and the return Gₜ in the entire scheduling process are calculated, and then the parameters of the task scheduling network are adjusted based on the gradient algorithm (such as gradient ascent or gradient descent) according to the return Gₜ, where the reward at each of the time steps include a carbon reward, an electricity cost reward and a task latency reward. In this way, during the task scheduling network training process, the carbon emission cost, electricity cost and task latency situation of the entire task execution process will be considered during the training process, which makes the data center scheduling process to be optimized in the direction of low carbon, economy, and low latency, thereby solving the technical problem of high data center operating costs in related technologies.

In a preferred embodiment, the determining unit is configured to: for any time step t, calculate the reward at the time step t according to a formula

$${r}_{t} = - {r}_{t}^{c a r b o n} - {r}_{t}^{cost} - {r}_{t}^{Q o s} ; where {r}_{t}^{c a r b o n}$$

is a carbon reward at the time step t,

$${r}_{t}^{cost}$$

is an electricity cost reward at the time step t, and

$${r}_{t}^{Q o s}$$

is a task latency reward at the time step t.

$${r}_{t}^{c a r b o n} = - {P}_{t}^{D C} \cdot {e}_{t} \cdot {p}^{carbon} , {r}_{t}^{c o s t} = - {P}_{t}^{D C} \cdot {q}_{t} ,$$

$${r}_{t}^{Q o s} = - {\sum }_{i = 1}^{N} ( {T}_{i}^{c p u} \cdot {p}^{c p u} + {T}_{i}^{MEM} \cdot {p}^{MEM} ) ; where$$

$${P}_{t}^{D C} = F ( M ) + {V}_{t} ( {U}_{t}^{c p u} , M ) , F ( M ) = M ( {P}_{idle} + ( PUE - 1 ) \cdot {P}_{peak} ) ,$$

$${V}_{t} ( {U}_{t}^{cpu} , M ) = {\sum }_{i = 1}^{M} ( {P}_{peak} - {P}_{idle} ) [ 2 {U}_{i , t}^{cpu} - {( {U}_{i , t}^{cpu} )}^{r} ] .$$

$${P}_{t}^{D C}$$

is a power of the data center at the time step t, eₜ is a system carbon emission rate, p^{carbon} is a carbon emission price, qₜ is an electricity price at the time step t, N is an integer greater than 1,

$${T}_{i}^{c p u}$$

is an occupancy rate for CPU resources of a task i, p^{cpu} is a price of CPU utilization,

$${T}_{i}^{MEM}$$

is an occupancy rate for memory resources of the task i, p^{MEM} is a price of memory resource utilization, M is the number of servers in the data center, F(M) is a static power,

$${V}_{t} ( {U}_{t}^{c p u} , M )$$

is a variable power, P_{idle} is a rated power when a server is idle, Pₚₑₐₖ is a rated power when the server is fully occupied, an index r is a constant, and PUE is an energy efficiency index of the data center.

The calculating unit includes: a scaling module, configured to scale up or scale down the rewards at the plurality of time steps to obtain a plurality of scaled rewards, where a range of numerical intervals to which the plurality of scaled rewards belong is narrower than a range of numerical intervals to which the plurality of rewards belong; and a calculating module, configured to calculate the return Gₜ according to the plurality of the scaled rewards, where the return is a cumulative reward from the time step t to the end of the scheduling process.

The scaling module is configured to: for any time step t, calculate the scaled reward

$${r}_{t}^{′}$$

at the time step t according to a formula

$${r}_{t}^{′} = ( {r}_{t} - μ ) / ( σ + ε ) ,$$

where rₜ is the reward at the time step t, y is updated with an increase of a value of k by a formula μ←μ′+(r−μ)/k, σ is updated with an increase of the value of k by the formula σ←sqrt(s/k), s is updated by calculating using a formula s←σ+(r−μ′)*(r−μ), where k=n−1, n is a serial number of the time step t, in a case where k=0, μ=r, α=r, r is a reward obtained at a first time step, and in a case serial k is not 0, μ=μ′.

The adjusting unit includes: a first determination module, configured to determine an estimation of a current state value; and an adjusting module, configured to adjust the parameters of the task scheduling network based on the gradient algorithm according to the return Gₜ and the estimation of the current state value.

The adjusting unit is configured to: iteratively update a parameter θ of the task scheduling network using an equation

$$θ ← θ + {α}^{θ} {γ}^{t} δ \frac{{Δ}_{θ} {π}_{θ} ( {a}_{t} \vert {s}_{t} , {θ}_{t} )}{{π}_{θ} ( {a}_{t} \vert {s}_{t} , {θ}_{t} )} ;$$

where α^{θ} is a learning rate of the parameter θ, δ is a difference between the return Gₜ and the estimation of the current state value, γ^{t} is a discount factor at the time step t, π_{θ}(aₜ|sₜ, θₜ) is a probability that the task scheduling network takes an action a in an s state at the time step t, ∇_{θ}π_{θ}(aₜ|sₜ, θₜ) is a derivative of \hat{v}(aₜ|sₜ, θₜ) with respect to θ.

The first determining module is configured to: calculate an inner product of a parameter vector w and a feature vector x(sₜ) to obtain the estimation \hat{v}(sₜ, w) of the current state value; where x(sₜ) is a feature vector of a state at the time step t.

The parameter vector w is iteratively updated by a formula w←w+α^{w}[Gₜ−\hat{v}(sₜ, w)]∇\hat{v}(sₜ, w); where α^{w} is a learning rate of \hat{v}(sₜ, w), and ∇\hat{v}(sₜ, w) is a derivative of \hat{v}(sₜ, w) with respect to w.

The scheduling unit includes: a second determining module, configured to determine a plurality of executable actions, where the actions are used to instruct any one of the tasks to be scheduled to any one server for execution; a inputting module, configured to input the plurality of executable actions into the task scheduling network, and output a probability that each of the executable actions is selected; a third determining module, configured to determine a plurality of scheduling actions from the plurality of executable actions according to the probability that each of the executable actions is selected; and a scheduling module, configured to schedule the plurality of tasks according to the plurality of scheduling actions.

The second determining module includes: a first determining sub-module, configured to determine one or more ready tasks from the plurality of tasks included in the job to be executed, where the ready tasks include tasks for which there is no parent task, and/or the ready tasks include tasks whose parent tasks have been executed, and the parent tasks are tasks that the ready tasks depend on when being executed; a second determining sub-module, configured to, for each of the ready tasks, determine one or more target servers, where the target servers are servers that meet computing resources required by the ready tasks; and a third determining sub-module, configured to determine that an action which schedules any one of the ready tasks to any one of the target servers is one of the executable actions.

The first determining sub-module is configured to: determine a front preset number of ready tasks from the plurality of tasks included in the job to be executed according to a task arrangement order.

In addition, an embodiment of the present application also provides a data center task scheduling method based on deep reinforcement learning, including: acquiring a job to be scheduled, where the job to be scheduled includes a plurality of tasks to be scheduled; and scheduling the plurality of tasks to be scheduled by using a task scheduling network, where the task scheduling network is trained by using the afore-mentioned task scheduling network training method based on deep reinforcement learning. Since the task scheduling network is trained using the afore-mentioned task scheduling network training method based on deep reinforcement learning, during the training process, the return Gₜ is calculated based on the carbon reward, the electricity cost reward and the task latency reward at each of the time steps, and the parameters of the task scheduling network are adjusted according to the gradient algorithm based on the return Gₜ, so the trained task scheduling network will consider the carbon emission cost, electricity cost and task latency situation of the entire task execution process, which makes the data center scheduling process to be optimized in the direction of low carbon, economy, and low latency, and solves the technical problem that a task scheduling algorithm in related technologies cannot achieve low-carbon economic operation of the data center on the basis of ensuring the timeliness of task processing.

In addition, an embodiment of the present application also provides a readable storage medium, on which computer instructions are stored, where when the computer instructions are executed by the processor, the afore-mentioned task scheduling network training method based on deep reinforcement learning is implemented; or when the computer instructions are executed by the processor, the afore-mentioned data center task scheduling method based on deep reinforcement learning is implemented.

Finally, an embodiment of the present application further provides a terminal device. The terminal device includes a memory and a processor, where the memory has computer instructions stored thereon, and when the computer instructions are executed by the processor, the afore-mentioned task scheduling network training method based on deep reinforcement learning is implemented; or when the computer instructions are executed by the processor, the afore-mentioned data center task scheduling method based on deep reinforcement learning is implemented.

It should be noted that the user information (including but not limited to user device information, user personal information, etc.) and data (including but not limited to data for analysis, stored data, displayed data, etc.) involved in the present application are all information and data authorized by the user or fully authorized by all parties, and the collection, use and processing of relevant data need to comply with relevant laws, regulations and standards of relevant countries and regions, and provide the corresponding operation entrance for the user to choose to authorize or refuse.

The serial numbers of the afore-mentioned embodiments of the present application are only for description and do not represent the advantages and disadvantages of the embodiments. Moreover, the steps shown in the flowchart of the accompanying drawings can be executed in a computer system such as a set of computer executable instructions. Although the logical order is shown in the flowchart, in some cases, the steps shown or described can be executed in a different order than here.

In the afore-mentioned embodiments of the present application, each embodiment is described with its own emphasis. For parts that are not described in detail in a certain embodiment, please refer to the relevant descriptions of other embodiments.

In the several embodiments according to the present application, it should be understood that the disclosed technical content can be implemented in other ways. The embodiments of the apparatus described above are merely schematic. For example, the division of the units described, can be a logical functional division, and they can be divided in other ways in the actual implementation. For example, multiple units or components can be combined or can be integrated into another system, or some features can be ignored, or not be implemented. On the other hand, the mutual coupling, direct coupling or communication connection shown or discussed can be indirect coupling or communication connection through some interfaces, units or modules, which can be electrical or in other forms.

The units illustrated as separate components may or may not be physically separated, and the components shown as units may or may not be physical units, i.e., they may be located in the same place or may be distributed to a plurality of units. Some or all of these units may be selected according to practical needs to achieve the purpose of the solution of the present embodiment.

In addition, respective functional units in respective embodiments of the present application may be integrated into one processing unit, or respective units may exist physically separately, or two or more units may be integrated into one unit. The integrated unit can be embodied in the form of hardware or in the form of software functional unit.

If the integrated unit is embodied in the form of a software functional unit and sold or used as an independent product, it can be stored in a computer-readable storage medium. Based on this understanding, the essence, or the part that contributes to the prior art of the technical solution of the present application, or all or part of the technical solution can be embodied in the form of a software product. The computer software product is stored in a storage medium and includes several instructions for causing a computer device (which may be a personal computer, server, network device, or the like) to execute all or part of the steps of the methods of respective embodiments of the present application. The storage media include: a universal serial bus (USB) flash drive, a read-only memory (ROM), a random access memory (RAM), a mobile hard disk, a magnetic disk or an optical disk, and other media that can store program codes.

The above are merely preferred implementations of the present application. It should be pointed out that, for those of ordinary skill in the art, several improvements and modifications can be made without departing from the principles of the present application. These improvements and modifications should also be regarded as the protection scope of the present application.

1. A task scheduling network training method based on deep reinforcement learning, comprising:
acquiring a job to be executed, wherein the job to be executed comprises a plurality of tasks;
scheduling the plurality of tasks by using a task scheduling network;
determining rewards at a plurality of time steps according to a scheduling result of the task scheduling network, wherein respective reward at each of the time steps comprises a carbon reward, an electricity cost reward and a task latency reward, the carbon reward represents a carbon emission cost of a data center at the time step, the electricity cost reward represents an electricity cost of the data center at the time step, the task latency reward represents a task latency of the data center at the time step;
calculating a return Gₜ according to the rewards at the plurality of time steps, wherein the return Gₜ is a cumulative reward from a time step t to the end of a scheduling process; and
adjusting parameters of the task scheduling network based on a gradient algorithm according to at least the return Gₜ.

2. The task scheduling network training method based on deep reinforcement learning according to claim 1, wherein the determining the rewards at the plurality of time steps according to the scheduling result of the task scheduling network comprises:
for any time step t, calculating the reward at the time step t according to a formula
$${r}_{t} = - {r}_{t}^{c a r b o n} - {r}_{t}^{c o s f} - {r}_{t}^{Q o s} ;$$
wherein
$${r}_{t}^{c a r b o n}$$
is a carbon reward at the time step t,
$${r}_{t}^{cost}$$
is an electricity cost reward at the time step t, and
$${r}_{t}^{Q o s}$$
is a task latency reward at the time step t.

3. The task scheduling network training method based on deep reinforcement learning according to claim 2, wherein
$${r}_{t}^{carbon} = - {P}_{t}^{D C} \cdot {e}_{t} \cdot {p}^{carbon} , {r}_{t}^{cost} = - {P}_{t}^{D C} \cdot {q}_{t} , {r}_{t}^{Q o s} = - {\sum }_{i = 1}^{N} ( {T}_{i}^{cpu} \cdot {p}^{cpu} + {T}_{i}^{MEM} \cdot {p}^{MEM} ) ;$$
$$wherein$$
$${r}_{t}^{Q o s} = - {\sum }_{i = 1}^{N} ( {T}_{i}^{cpu} \cdot {p}^{cpu} + {T}_{i}^{MEM} \cdot {p}^{MEM} ) , F ( M ) = M ( {P}_{idle} + ( P U E - 1 ) \cdot {P}_{p e a k} ) , {V}_{t} ( {U}_{t}^{cpu} , M ) = {\sum }_{i = 1}^{M} ( {P}_{p e a k} - {P}_{idle} ) [ 2 {U}_{i , t}^{cpu} - {( {U}_{i , t}^{cpu} )}^{r} ] , {P}_{t}^{D C}$$
is a power of the data center at the time step t, eₜ is a system carbon emission rate, p^{carbon} is a carbon emission price, qₜ is an electricity price at the time step t, N is an integer greater than 1,
$${T}_{i}^{cpu}$$
is an occupancy rate for CPU resources of a task i, p^{cpu} is a price of CPU utilization,
$${T}_{i}^{MEM}$$
is an occupancy rate for memory resources of the task i p^{MEM} is a price of memory resource utilization, M is a number of servers in the data center, F(M) is a static power,
$${V}_{t} ( {U}_{t}^{cpu} , M )$$
is a variable power, P_{idle} is a rated power in a condition that a server is idle, Pₚₑₐₖ is a rated power in a condition that the server is fully occupied, an index r is a constant, and PUE is an energy efficiency index of the data center.

4. The task scheduling network training method based on deep reinforcement learning according to claim 1, wherein the calculating the return Gₜ according to the rewards at the plurality of time steps comprises:
scaling up or scaling down the rewards at the plurality of time steps to obtain a plurality of scaled rewards, wherein a range of numerical intervals to which the plurality of scaled rewards belong is narrower than a range of numerical intervals to which the plurality of rewards belong; and
calculating the return Gₜ according to the plurality of the scaled rewards.

5. The task scheduling network training method based on deep reinforcement learning according to claim 4, wherein the scaling up or scaling down the rewards at the plurality of time steps to obtain the plurality of scaled rewards comprises:
for any time step t, calculating the scaled reward rₜ at the time step t according to a formula rₜ′=(rₜ−μ)/(σ+ε), wherein rₜ is the reward at the time step t, μ is updated with an increase of a value of k by a formula μ←μ′+(r−μ)/k, σ is updated with an increase of the value of k by a formula σ←sqrt(s/k), s is updated by calculating using a formula s←σ+(r−μ′)*(r−μ), wherein k=n−1, n is a serial number of the time step t, in a case where k=0, μ=r, σ=r, r is a reward obtained at a first time step, and in a case where k is not 0, μ=μ′.

6. The task scheduling network training method based on deep reinforcement learning according to claim 1, wherein the adjusting the parameters of the task scheduling network based on the gradient algorithm according to the return Gₜ comprises:
determining an estimation of a current state value; and
adjusting the parameters of the task scheduling network based on the gradient algorithm according to the return Gₜ and the estimation of the current state value.

7. The task scheduling network training method based on deep reinforcement learning according to claim 6, wherein the adjusting the parameters of the task scheduling network based on the gradient algorithm according to the return Gₜ and the estimation of the current state value comprises:
iteratively updating a parameter θ of the task scheduling network using an equation
$$θ ← θ + {α}^{θ} {γ}^{t} δ \frac{{∇}_{θ} {π}_{θ} ( {a}_{t} \vert {s}_{t} , {θ}_{t} )}{{π}_{θ} ( {a}_{t} \vert {s}_{t} , {θ}_{t} )} ,$$
wherein α^{θ} is a learning rate of the parameter θ, δ is a difference between the return Gₜ and the estimation of the current state value, γ^{t} is a discount factor at the time step t, π_{θ}(aₜ|sₜ, θₜ) is a probability that the task scheduling network takes an action a in an s state at the time step t, ∇_{θ}π_{θ}(aₜ|sₜ, θₜ) is a derivative of π_{θ}(aₜ|sₜ, θₜ) with respect to θ.

8. The task scheduling network training method based on deep reinforcement learning according to claim 6, wherein the determining the estimation of the current state value comprises:
calculating an inner product of a parameter vector w and a feature vector x(sₜ) to obtain the estimation \hat{v}(st, w) of the current state value;
wherein x(sₜ) is a feature vector of a state at the time step t.

9. The task scheduling network training method based on deep reinforcement learning according to claim 8, wherein the parameter vector w is iteratively updated by a formula w←w+α^{w}[Gₜ−\hat{v}(sₜ, w)]∇\hat{v}(sₜ, w);
wherein α^{w} is a learning rate of \hat{v}(sₜ, w), and ∇\hat{v}(sₜ, w) is a derivative of \hat{v}(sₜ, w) with respect to w.

10. The task scheduling network training method based on deep reinforcement learning according to claim 1, wherein the scheduling the plurality of tasks by using the task scheduling network comprises:
determining a plurality of executable actions, wherein the actions are used to instruct any one of the tasks to be scheduled to any one server for execution;
inputting the plurality of executable actions into the task scheduling network, and outputting a probability that each of the executable actions is selected;
determining a plurality of scheduling actions from the plurality of executable actions according to the probability that each of the executable actions is selected; and
scheduling the plurality of tasks according to the plurality of scheduling actions.

11. The task scheduling network training method based on deep reinforcement learning according to claim 10, wherein the determining the plurality of executable actions comprises:
determining one or more ready tasks from the plurality of tasks comprised in the job to be executed, wherein the ready tasks comprise at least one of tasks for which there is no parent task; and tasks whose parent tasks have been executed, and the parent tasks are tasks that the ready tasks depend on in a condition that the ready tasks are executed;
for each of the ready tasks, determining one or more target servers, wherein the target servers are servers that meet computing resources required by the ready tasks; and
determining that an action which schedules any one of the ready tasks to any one of the target servers is one of the executable actions.

12. A data center task scheduling method based on deep reinforcement learning, comprising:
acquiring a job to be scheduled, wherein the job to be scheduled comprises a plurality of tasks to be scheduled; and
scheduling the plurality of tasks to be scheduled by using a task scheduling network, wherein the task scheduling network is trained by using the task scheduling network training method based on deep reinforcement learning according to claim 1.

13. A non-transitory readable storage medium with computer programs stored thereon, wherein when the computer instructions are executed by a processor, the processor is configured to perform the following operations:
acquiring a job to be executed, wherein the job to be executed comprises a plurality of tasks;
scheduling the plurality of tasks by using a task scheduling network;
determining rewards at a plurality of time steps according to a scheduling result of the task scheduling network, wherein respective reward at each of the time steps comprises a carbon reward, an electricity cost reward and a task latency reward, the carbon reward represents a carbon emission cost of a data center at the time step, the electricity cost reward represents an electricity cost of the data center at the time step, the task latency reward represents a task latency of the data center at the time step;
calculating a return Gₜ according to the rewards at the plurality of time steps, wherein the return Gₜ is a cumulative reward from a time step t to the end of a scheduling process; and
adjusting parameters of the task scheduling network based on a gradient algorithm according to at least the return Gₜ.

14. A terminal device, comprising a memory and a processor, wherein the memory has computer instructions stored thereon, when the computer instructions are executed by the processor, the processor is configured to:
acquire a job to be executed, wherein the job to be executed comprises a plurality of tasks;
schedule the plurality of tasks by using a task scheduling network;
determine rewards at a plurality of time steps according to a scheduling result of the task scheduling network, wherein respective reward at each of the time steps comprises a carbon reward, an electricity cost reward and a task latency reward, the carbon reward represents a carbon emission cost of a data center at the time step, the electricity cost reward represents an electricity cost of the data center at the time step, the task latency reward represents a task latency of the data center at the time step;
calculate a return Gₜ according to the rewards at the plurality of time steps, wherein the return Gₜ is a cumulative reward from a time step t to the end of a scheduling process; and
adjust parameters of the task scheduling network based on a gradient algorithm according to at least the return Gₜ.

15. The terminal device according to claim 14, wherein the processor is configured to:
for any time step t, calculate the reward at the time step t according to a formula
$${r}_{t} = - {r}_{t}^{carbon} - {r}_{t}^{cost} - {r}_{t}^{Q o s} ;$$
wherein
$${r}_{t}^{carbon}$$
is a carbon reward at the time step t,
$${r}_{t}^{cost}$$
is an electricity cost reward at the time step t, and
$${r}_{t}^{Q o s}$$
is a task latency reward at the time step t.

16. The terminal device according to claim 15, wherein
$${r}_{t}^{carbon} = - {P}_{t}^{D C} \cdot {e}_{t} \cdot {p}^{carbon} ,$$
$${r}_{t}^{cost} = - {P}_{t}^{D C} \cdot {q}_{t} , {r}_{t}^{Q o s} = - {\sum }_{i = 1}^{N} ( {T}_{i}^{cpu} \cdot {p}^{cpu} + {T}_{i}^{MEM} \cdot {p}^{MEM} ) ;$$
$$wherein$$
$${r}_{t}^{Q o s} = - {\sum }_{i = 1}^{N} ( {T}_{i}^{cpu} \cdot {p}^{cpu} + {T}_{i}^{MEM} \cdot {p}^{MEM} ) , F ( M ) = M ( {P}_{idle} + ( P U E - 1 ) \cdot {P}_{p e a k} ) , {V}_{t} ( {U}_{t}^{cpu} , M ) = {\sum }_{i = 1}^{M} ( {P}_{p e a k} - {P}_{idle} ) [ 2 {U}_{i , t}^{cpu} - {( {U}_{i , t}^{cpu} )}^{r} ] , {P}_{t}^{D C}$$
is a power of the data center at the time step t, eₜ is a system carbon emission rate, p^{carbon} is a carbon emission price, qₜ is an electricity price at the time step t, N is an integer greater than 1,
$${T}_{i}^{cpu}$$
is an occupancy rate for CPU resources of a task i, p^{cpu} is a price of CPU utilization,
$${T}_{i}^{MEM}$$
is an occupancy rate for memory resources of the task i p^{MEM} is a price of memory resource utilization, M is a number of servers in the data center, F(M) is a static power,
$${V}_{t} ( {U}_{t}^{cpu} , M )$$
is a variable power, P_{idle} is a rated power in a condition that a server is idle, Pₚₑₐₖ is a rated power in a condition that the server is fully occupied, an index r is a constant, and PUE is an energy efficiency index of the data center.

17. The terminal device according to claim 14, wherein the processor is configured to:
scale up or scale down the rewards at the plurality of time steps to obtain a plurality of scaled rewards, wherein a range of numerical intervals to which the plurality of scaled rewards belong is narrower than a range of numerical intervals to which the plurality of rewards belong; and
calculate the return Gₜ according to the plurality of the scaled rewards.

18. The terminal device according to claim 17, wherein the processor is configured to:
for any time step t, calculate the scaled reward rₜ′ at the time step t according to a formula rₜ=(rₜ−μ)/(σ+ε), wherein rₜ is the reward at the time step t, μ is updated with an increase of a value of k by a formula μ−μ′+(r−μ)/k, σ is updated with an increase of the value of k by a formula σ←sqrt(s/k), s is updated by calculating using a formula s←σ+(r−μ′)*(r−μ), wherein k=n−1, n is a serial number of the time step t, in a case where k=0, μ=μ′, σ=r, r is a reward obtained at a first time step, and in a case where k is not 0, μ=μ′.

19. The terminal device according to claim 14, wherein the processor is configured to:
determine an estimation of a current state value; and
adjust the parameters of the task scheduling network based on the gradient algorithm according to the return Gₜ and the estimation of the current state value.

20. The terminal device according to claim 14, wherein the processor is configured to:
determine a plurality of executable actions, wherein the actions are used to instruct any one of the tasks to be scheduled to any one server for execution;
input the plurality of executable actions into the task scheduling network, and output a probability that each of the executable actions is selected;
determine a plurality of scheduling actions from the plurality of executable actions according to the probability that each of the executable actions is selected; and
schedule the plurality of tasks according to the plurality of scheduling actions.
